(19) United States
(12) Patent Application Publication
(10) Pub. No.: US 2003/0158902 A1
(43) Pub. Date: Aug. 21, 2003

(54) Multimedia instant communication system and method

(76) Inventor: Dotan Volach, Haifa (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 10/284,481

(22) Filed: Oct. 31, 2002

Related U.S. Application Data
(60) Provisional application No. 60/330,818, filed on Oct. 31, 2001.
(60) Provisional application No. 60/330,836, filed on Oct. 31, 2001.
(60) Provisional application No. 60/330,837, filed on Oct. 31, 2001.

(51) Int. Cl. G06F 15/16

(52) U.S. Cl. 709/206; 709/246

(57) ABSTRACT

Described is a rich content delivery system including a rich content unit to send multi-media communications generally instantly, a presence unit to communicate with the messaging unit, and a network access layer to communicate with the rich content unit. Also described is a rich content delivery system for wireless devices including a rich content unit to send multi-media communications to wireless devices, a presence unit to communicate with the rich content unit, and a network access layer to communicate with said rich content unit.

### CROSS REFERENCE TO RELATED APPLICATIONS

This application claims the priority of U.S. Provisional Patent Application Nos. 60/330,818, 60/330,836, and 60/330,837, all filed on Oct. 31, 2001 (and entitled “Data Transfer Between Devices On Wireline And Wireless Networks”, “Advanced Device Capabilities For Wireline And Wireless Networks”, and “Instant Multi-Media Message Architecture” respectively), which are incorporated in their entirety herein by reference.

### FIELD OF THE INVENTION

The present invention relates generally to multi-media instant communication systems.

### BACKGROUND OF THE INVENTION

There exist today systems of instant messaging (IM) wherein messages may be sent from one user of a system to another user of a similar system. For example, by means of the short message system (SMS) used in telephone systems, short text messages may be sent between users, even when the users are connected through different carriers. These systems are based on the SS7 telephony standard.

In computer network technology, other instant messaging systems exist using different standards. For example, internet based IM service X and internet based IM service Y allow instant messages to be sent between their subscribers. Messages, which are not limited to text, may be complex, large, may vary in size, and may require special processing. To use this service, a subscriber must predefine a list of contacts often referred to as a “buddy list” or “friends list”. Furthermore, users may receive status information on members of their buddy lists.

These two types of systems are inherently different. For example, messages sent using SMS are limited to a short text string but may be sent to anyone with a device capable of receiving the message, even if that person uses a different carrier. Instant messages sent over computer networks, on the other hand, may not be limited to a short text string, but may only be sent to a predefined list of subscribers within the messaging service. For example, currently messages may not be sent between internet based IM service X and internet based IM service Y users. Furthermore, delivery may be done in two phases, first a notification is sent by push technology, and then, when requested, the actual message may be sent.

Email systems are a form of non-real time messaging. Email systems are based on a queue paradigm. A user sends a message to an Email server, where it is stored, and the recipient is responsible for retrieving message (by pull technology).

Another developing type of messaging system is multi-media service (MMS). This service, however, is non real-time. Standards are being developed for this type of system, for example by 3GPP (3rd Generation Partnership Project). MMS will allow sending of multi-media messages including text, images, audio and video.

### SUMMARY OF THE INVENTION

There is provided, in accordance with some embodiments of the present invention, a rich content instant delivery system including a rich content unit to send multi-media communications generally instantly, a presence unit to communicate with the messaging unit, and a network access layer to communicate with the rich content unit.

Furthermore, there is provided, in accordance with some embodiments of the present invention, a rich content delivery system for wireless devices including a rich content unit to send multi-media communications to wireless devices, a presence unit to communicate with the rich content unit, and a network access layer to communicate with the rich content unit.

In addition, there is provided, in accordance with some embodiments of the present invention, A method for delivering a multi-media instant communication comprising initial processing of a multi-media instant communication, routing of at least one information request generated by the initial processing, determining service details of the communication, discovering presence information, extracting and transcoding envelope information of the communication, transcoding content of the communication; and sending a processed multi-media instant communication.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings, in which:

FIG. 1 is a figurative illustration of the receipt of a communication by a client in a multi-media instant communication system, operative in accordance with exemplary embodiments of the present invention;

FIG. 2 is a block diagram illustration of a multi-media instant communication system architecture, operative in accordance with exemplary embodiments of the present invention;

FIG. 3 is a block diagram illustration of rich content unit 24 of FIG. 2, operative in accordance with an embodiment of the present invention;

FIG. 4 is a block diagram illustration of content handler 52 of FIG. 3, operative in accordance with an embodiment of the present invention;

FIG. 5 is a block diagram illustration of presence unit 26 of FIG. 2, operative in accordance with an embodiment of the present invention;

FIG. 6A is a sequence diagram illustration of several exemplary methods for rich content delivery, in accordance with an embodiment of the present invention;

FIG. 6B is a flow chart diagram of a rich content delivery method, in accordance with an embodiment of the present invention.

### DETAILED DESCRIPTION OF THE PRESENT INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, and components have not been described in detail so as not to obscure the present invention.

Unless specifically stated otherwise, as apparent from the following discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), FLASH memory, magnetic or optical cards, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

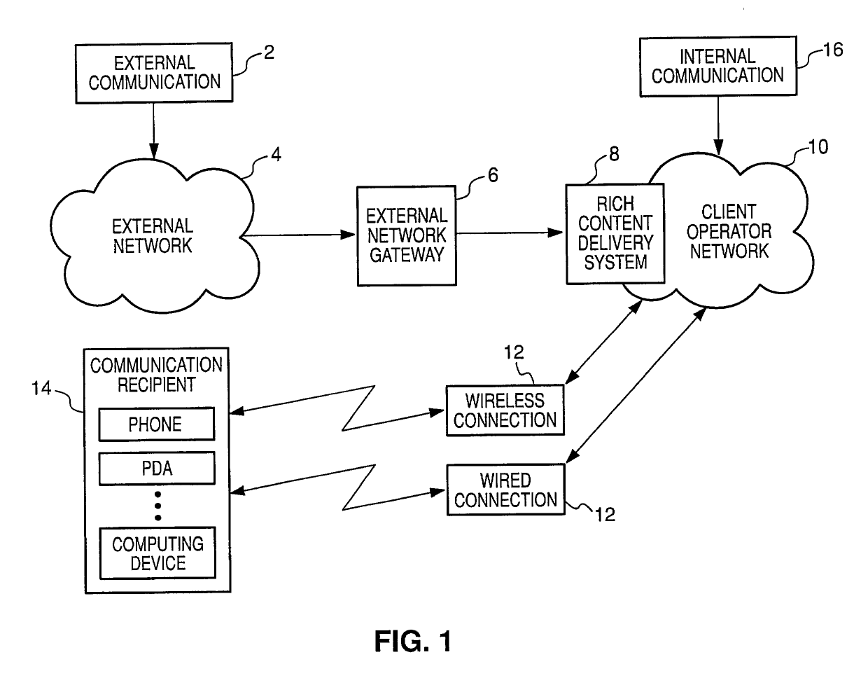

Reference is now made to FIG. 1, which is a figurative illustration of receipt of a communication by a client in an exemplary multi-media instant communication system operative in accordance with exemplary embodiments of the present invention. A multi-media instant communication system may comprise an external communication source 2, an external network 4, an external network gateway 6, a rich content delivery system 8, a client operator network 10, an intermediary node 12, and a recipient device 14. Alternatively, a multi-media instant messaging system may comprise an internal communication source 16, a client operator network 10, an intermediary node 12, and a recipient device 14 wherein network 10 comprises a rich content delivery system 8.

Communication sources 2 and 16 may be any appropriate devices known in the art, for example, mobile, stationary, and landline devices. Exemplary devices include various types of telephones, personal digital assistants (PDAs), and computing devices. Thus, rich content delivery system 8 may be compatible with communications input from any type of device that may be used to create and send various types of content. It is noted that a communication hereinbelow may comprise any type of content, for example, text, audio/video, instructions for a device, and game actions.

External network 4 and client operator network 10 may comprise any appropriate network known in the art, for example, wired networks, wireless networks, or any combination thereof. Exemplary networks include the Internet, cellular networks, wireless access protocol (WAP) networks, and plain old telephone system (POTS) networks. Client operator network 10 may comprise a portion of rich content delivery system 8. A portion of rich content delivery system 8 may be external to client operator network 10.

Intermediary node 12 may be a wired network device or a wireless device. Recipient device 14 may be any appropriate device known in the art, for example, a mobile, stationary, or landline device. Exemplary devices include various types of telephones, PDAs, and computing devices. The communication may be received as input by any appropriate application or service running on the device or may be routed to the display area of the device. Exemplary recipients may include a mobile phone display, an email server, a voice capable device, an instant communication service capable device, a multi-media service capable device, or services such as internet based instant messaging (IM) services X, internet based IM services Y, Internet Relay Chat (IRC), and Jabber.

The target recipient of a communication may be connectable to client operator network 10 by means of recipient device 14. Recipient device 14 may connect to client operator network 10 by means of an appropriate intermediary node 12. If recipient device 14 is a wireless device such as a mobile telephone or a PDA for example, intermediary node 12 may be a wireless connection such as an antenna or other radio frequency device, Blue Tooth infra-red device, or IEEE P802.11 capable device. If recipient device 14 is a wired or fixed device, intermediary node 12 may be a wired connection such as a computing device or other appropriate connection.

If a communication is sent to recipient device 14 from a device connected to the same client operator network 10, hereinbelow the communication is referred to as internal communication 16. In an embodiment of the present invention, such a communication may be handled within client operator network 10 by rich content delivery system 8.

If a communication is sent to recipient device 14 from a device connected to a different network, hereinbelow the communication is referred to as external communication 2. External communication 2 may be sent to its operator network, external network 4. The communication may be forwarded to the network of the recipient, client operator network 10, via external network gateway 6. Communications received from an external network may be handled by rich content delivery system 8.

Rich content delivery system 8 may have access to information regarding the capabilities of recipient device 14. Rich content delivery system 8 may also receive details about the communication itself, such as the type of content or size. It may perform any necessary transcoding or manipulation of the communication so that it may be delivered to recipient device 14 in a manner that is optimal for the capabilities of recipient device 14. The operation of rich content delivery system 8 is explained in detail hereinbelow.

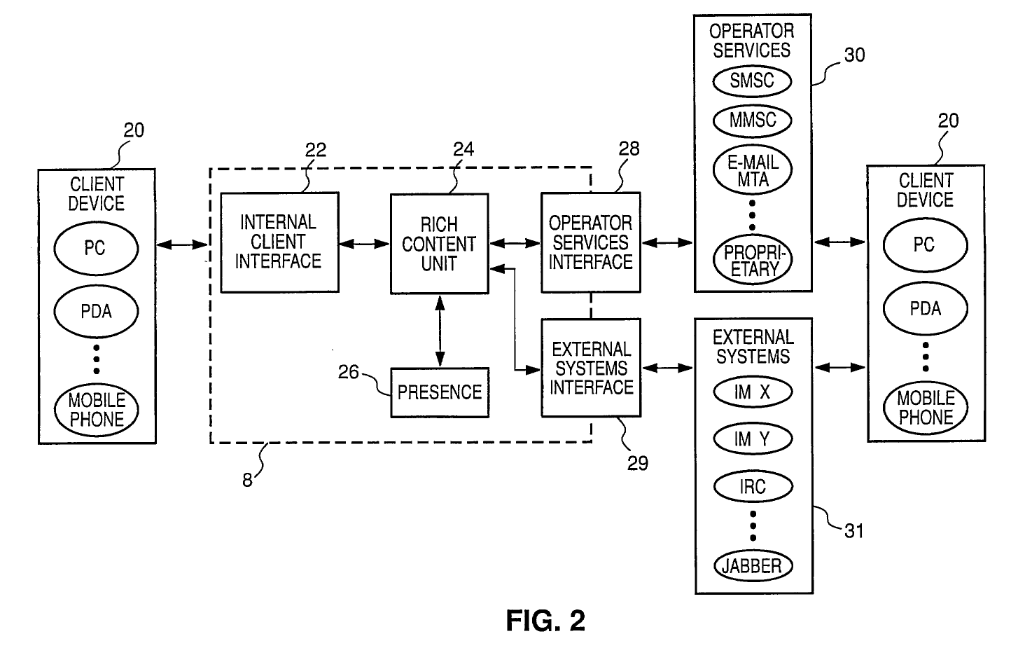

FIG. 2, to which reference is now made, is a block diagram illustration of a multi-media instant communication system architecture operative in accordance with an embodiment of the present invention, comprising at least one client device 20, internal client interface 22, rich content unit 24, presence unit 26, operator services interface 28, external systems interface 29, operator services 30, and external systems 31. As may be seen in the dashed box 8 in FIG. 2, rich content delivery system 8 of FIG. 1 may comprise rich content unit 24, presence unit 26, and portions of internal client interface 22, operator services interface 28, and external systems interface 29.

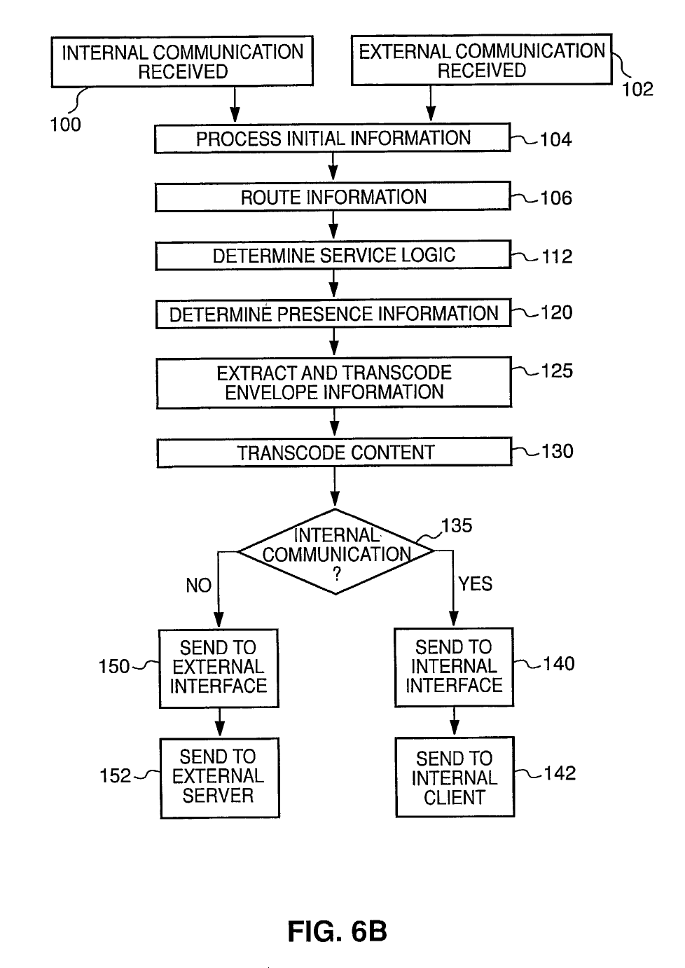

Communications may be generated, as explained hereinabove, from any appropriate device known in the art. Such a communication source may be, for example, a PDA, a mobile telephone, a PC, email, or an instant messaging system. If the communication is sent from a user on the same operator network as the recipient, it may be received by rich content delivery system 8 through client interface 22. If the communication is sent from a user on a different operator network, it may be received by rich content delivery system 8 through either operator services interface 28 or external systems interface 29. Further details regarding communication flow will be explained hereinbelow with respect to FIG. 6A.

A communication received by rich content delivery system 8 through any of the interfaces may be input to rich content unit 24. After appropriate processing by rich content unit 24 and presence unit 26, as explained hereinbelow, the communication may be forwarded, as appropriate, to client interface 22, operator services interface 28, or external systems interface 29 for delivery to the recipient.

Internal client interface 22 may be comprised of at least one protocol interface to communicate from rich content unit 24 to various client devices 20. The protocol interface used may depend on the particular client device 20 receiving the communication. For example, mobile phones, PDAs, PCs, or web browsers may all require different interfaces. Protocols such as WAP, TCP/IP, HTTP/S, SMTP, SOAP, and SMS may be used to communicate with client device 20.

Operator services interface 28 may comprise gateways to operator services 30 of client operator network 10 (FIG. 1). Operator services 30 may comprise standard gateways to services on external network 4 (FIG. 1). Exemplary gateways may include ESME (External Short Messaging Entity) and EMME (External Multimedia Messaging Entity). Exemplary operator services 30 may include SMSC (Short Messaging Service Center), MMSC (Multimedia Messaging Service Center), E-Mail MTA (Message Transfer Agent), and a proprietary interoperability service access point. When external network 4 also includes a rich content delivery system 8, the proprietary interoperability service access point may be used and may allow interoperability between rich content delivery systems 8 on various operator networks.

External systems interface 29 may comprise bridges to external systems 31. Different external systems 31 may use different and possibly proprietary protocols and addressing schemes; for example, internet based IM services X messages may not be compatible with internet based IM services X messages. Exemplary external systems 31 may include internet based IM services X, internet based IM services Y, IRC, and Jabber.

It is noted that different services and systems may use different protocols. Thus, for example, to send an instant communication from a mobile phone to an email user on a laptop computer, it may be necessary to convert the SMS protocol used to send the instant communication to the SMTP protocol used by email servers.

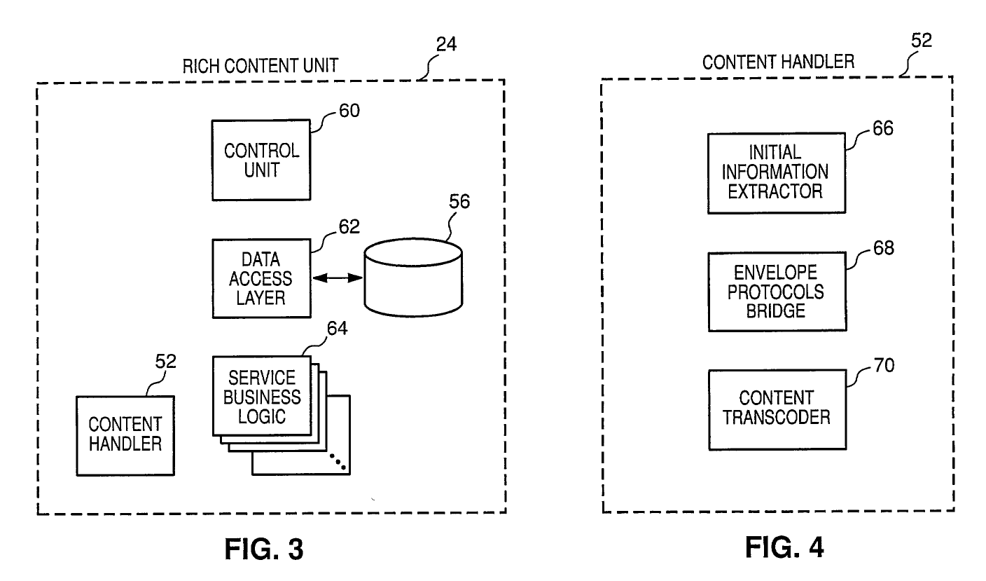

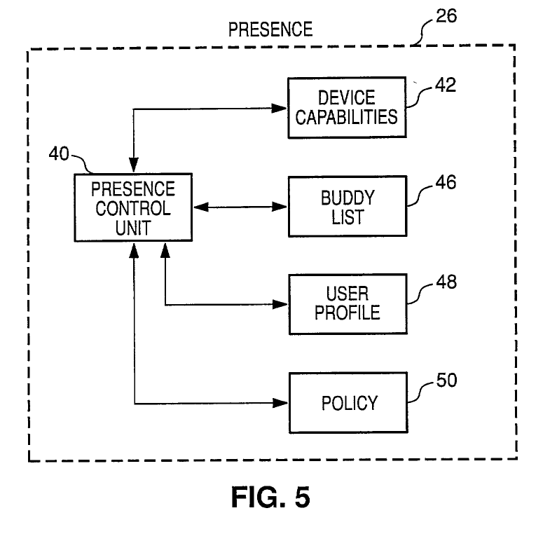

Rich content unit 24 may be responsible for control, content handling, and data related functions within rich content delivery system 8. Rich content unit 24 may, for example, determine the source and destination of communications (independently of the type of communication being sent), perform functions similar to those performed by an SMS unit in the current art, and perform protocol dependent functions. Rich content unit 24 is explained in further detail hereinbelow with respect to FIGS. 3 and 4.

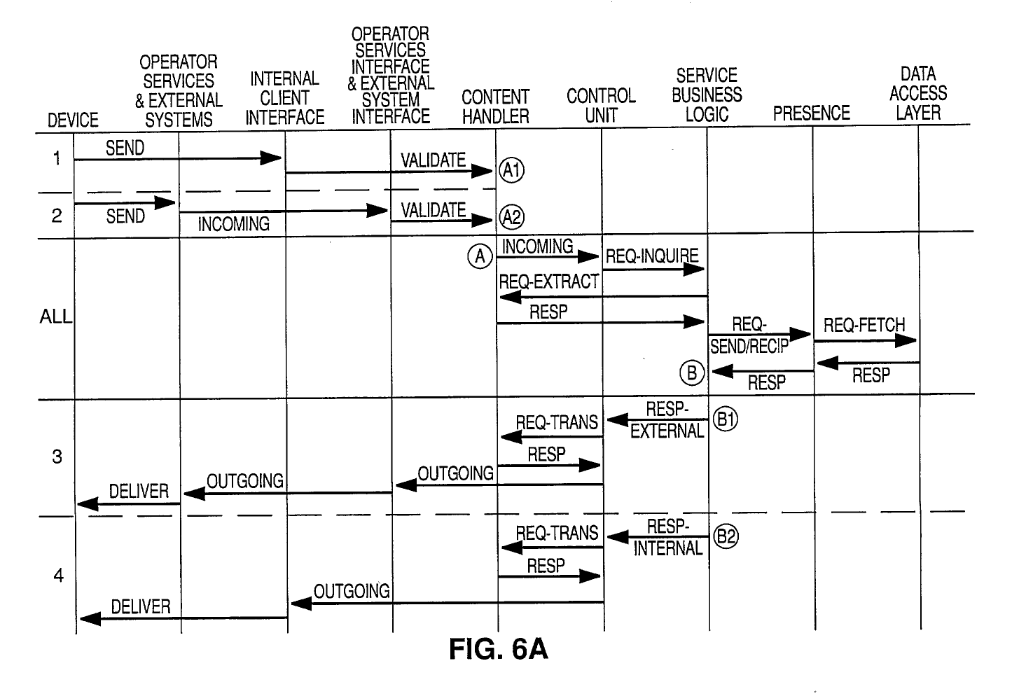

Presence unit 26 may be responsible for the “rich” portions of the messaging service. For example, presence unit 26 may have access to information regarding device capabilities, users, and networking information. This may include best delivery method, user preferences, and presence. These functions are described hereinbelow in greater detail with respect to FIG. 5.

For instant or real time communications, presence unit 26 may find a suitable client device such as a mobile phone, PDA, or computing device, which all may insure instant delivery if they are connected. Furthermore, several protocol technologies may allow immediate delivery even when user is busy, for example, TCP, GPRS, and WAP-PUSH. Rich content delivery system 8 (FIG. 1) may implement both “push” and “pull” models, which may allow instant access, as the server may “push” communications. Furthermore, rich content delivery system 8, may use a “poll” and “pull” system which may allow a semi-instant delivery, depending on the “poll” interval.

Reference is now made to FIG. 3, which is a detailed block diagram illustration of rich content unit 24 of FIG. 2, operative in accordance with an embodiment of the present invention. Rich content unit 24 may comprise control unit 60, data access layer 62, at least one service business logic 64, content handler 52, and database 56.

Control unit 60 may comprise control and routing capabilities. It may comprise the stateless information of rich content unit 24. Control unit 60 may control input and output between rich content unit 24 and the network access layer (not shown). The network access layer may comprise portions of client interface 22, operator services interface 28, and external systems interface 29 as shown and discussed hereinabove with respect to FIG. 2.

Data access layer 62, database 56, and service business logic 64 may comprise the state data that may be used by rich content delivery system 8. Data access layer 62 may control access to database 56 by other components of rich content unit 24. Data access layer 62 may pass data to and from the network access layer via control unit 60. Data access layer 62 may further retrieve and update information in database 56 that may be used by presence unit 26 (FIG. 2). Data may also be inserted into database 56 by data access layer 62, from external data repositories such as CRM, Directory service. In addition, data may be present on these external data repositories and may be fetched on demand by data access layer 62.

Each service business logic unit 64 may comprise logic and information related to a different service provided by client operator network 10. For example, a service business logic unit 64 for instant communications may comprise information regarding instant communication delivery. A given service business logic 64 may consult other related service business logics 64. For example, an instant messaging business logic unit 64 may communicate with a pricing business logic unit 64 and thus may enrich the instant messaging service with pricing information. In a further example, a multi-media service business logic unit 64 may also consult the pricing business logic unit 64.

Content handler 52 may comprise information related to the communication details. Control unit 24 may have no knowledge of the internals of the communication; rather, content handler 52 may provide the information as needed. For example, control unit 60 may take a given field of the communication, and content handler 52 may provide it with information such as content type, recipient, and transcoded content. This is discussed in further detail hereinbelow with respect to FIG. 4.

When processing has been completed by the components of rich content unit 24, control unit 60 may forward an output communication to the network access layer.

FIG. 4, to which reference is now made, is a detailed block diagram illustration of content handler 52 of FIG. 3, operative in accordance with an embodiment of the present invention, comprising initial information extractor 66, envelope protocols bridge 68, and content transcoder 70.

Content handler 52 may manipulate communication content and addressing into a format appropriate for a given device. Other components of rich content unit 24 (FIG. 2) may, for example, have access to information regarding the type of device to which the communication is being sent. Presence unit 26 (FIG. 2) may, for example, have access to user presence information or information regarding the capabilities of specific client devices. Hence, content handler 52 may consult with these units in determining the correct format for the communication content and addressing.

Initial information extractor 66 may extract from the communication information that may be required to begin processing and validating the communication. For example, initial information extractor 66 may extract the communication type and delivery instructions, such as the recipient and expiry date/time.

Envelope protocols bridge 68 may receive and/or extract envelope and meta data such as delivery instructions or structural data (e.g. layout information). Envelope protocols bridge 68 may convert the delivery instructions to conform to the required delivery protocol specifications.

Content transcoder 70 may transcode the content of the communication from one format to another. For example, it may transcode a communication appropriate for display on a computer to a communication deliverable efficiently on a mobile telephone or an audio device, or it may transcode formats of the communication content or content part (such as changing a picture from JPEG to GIF). Content transcoder 70 may work independently on each part of the content and may be capable of manipulating the content in numerous ways that may depend on the content type, data and structure of each part. The transcoding process may interact with the elements within presence 26 (FIG. 2) which handle device capabilities. This may be necessary as the content may be to conform to the capabilities of the sending and receiving devices.

Reference is now made to FIG. 5, which is a detailed block diagram illustration of presence unit 26 of FIG. 2, operative in accordance with an embodiment of the present invention. Presence unit 26 may comprise presence control unit 40, device capabilities 42, buddy list 46, user profile 48, and policy 50. Presence control unit 40 may control information flow between elements of presence unit 26 and to and from rich content unit 24 (FIG. 2).

Presence unit 26 may allow semi-real-time delivery of communications. A recipient may be logged onto several devices; presence unit 26 may determine the client device most suitable for delivery of the current communication. Presence unit 26 may find a client that is logged on, may take several factors into consideration, for example, time limitations, preferences etc., and may determine a delivery strategy. Thus, rich content enabled client devices may be connected to the presence unit 26, some of which may be instant and some may not (e.g. email). Hence, it may be that a client may not, at a given time, be able to receive instant communications. In such a case, either the communication may be delivered to a non instant client or the communication may wait for delivery on an appropriate device until it is accessed.

Device capabilities 42 may comprise information related to a specific client device, for example, vendor, model, type of device, screen size, color capabilities, supported transports, encodings, and so on. Device capabilities 42 may obtain device information in several ways. For example, information may be entered by a user, it may be obtained from external systems, or it may be discovered in various ways. For example, device capabilities may be discovered by sending a type 0 SMS message; if the device answers, it may be assumed that the device has the capability to receive SMS messages in general.

Information obtained from external systems may include, for example, information from an HLR (Home Location Register), which may indicate in which cell the device is located and whether it is logged on; GPRS (General Packet Radio Service) information, which may also provide location information; billing system information, which may detail services that require specific capabilities; or an IMEI (ISDN Mobile Equipment Identifier).

Buddy list 46 may comprise information similar to that comprised by buddy lists known in the art. For example, the information associated with a buddy on the buddy list may include availability, a list of instant messaging clients used by a particular buddy, and the type of device used (e.g. PC, Internet, WAP, SMS, PDA). Buddy list 46 may further include information such as text further detailing the availability of the buddy (e.g. “At lunch”), the sender or recipient location, and a specification of the type of data a buddy may receive about the user.

Buddy list 46 may comprise information that may be derived and updated from external sources, such as a communication network. Such information may be dynamic, for example, availability, which may update the status of the user or buddy with values such as online, busy, not available, away, offline. Existing standards known in the art, such as UA-prof and CC/PP, may be used for those attributes which they cover.

User profile 48 may comprise internal user information and access to external user information. User profile 48 attributes, which may be passive in nature, may include for example, user name, email address, mobile telephone number, language preference, and hobbies. A source of external user information may be a customer relationship management (CRM) system, which may comprise information that may be obtained by network operators.

Policy 50 may receive input from device capabilities 42, buddy list 46, and user profile 48 via presence control unit 40. These inputs may be used in creating a policy that may include details for correct routing and transcoding of communications. Policy 50 may further include logic information concerning usage. An example of such logic may be that a given user is available by telephone at certain hours and otherwise is available only by SMS.

FIG. 6A, to which reference is now made, is a sequence diagram illustration of several exemplary methods for rich content delivery, in accordance with an embodiment of the present invention. In the description hereinbelow reference numerals from FIGS. 1-5 may be used for clarification purposes. There may be two input paths (rows labeled 1 and 2) both of which continue with the same path (row labeled ALL). There may also be two output paths (rows labeled 3 and 4). Any combination of input and output paths may be possible. Hence, there may be four possible paths a communication may take from input to output.

Path 1 may be taken by an internal communication. An internal communication 16 may be received by internal client interface 22 from a device 20 (arrow send). The communication may be sent to initial information extractor 66 of content handler 52 for validation (arrow validate). The path may continue from “A1” at “A”.

Alternatively, path 2 may be taken by an external communication. An external communication 2 may be received by either operator services 30 or external systems 31 (arrow send). The communication may be forwarded to operator services interface 28 or external systems interface 29 (arrow incoming). It may then be sent to initial information extractor 66 of content handler 52 for validation (arrow validate). The path may continue from “A2” at “A”.

Both path 1 and path 2 may continue at “A” (row labeled ALL). The communication may have been sent to initial information extractor 66 which may perform a first validation, for example, whether the communication looks complete and correct. Furthermore, it may perform the initial extraction which may comprise extracting a session identifier, recipient, communication type, service and other security keys.

After initial processing the communication may be sent to control unit 60 of rich content unit 24 (arrow incoming) which may route the communication to service business logic 64 (arrow request-inquire). This may comprise, for example, a request for rules regarding the requested service.

Once the service logic has been retrieved, envelope protocols bridge 68 of content handler 52 may extract and check necessary information, for example, the headers and communication type (arrow request-extract). A response may be returned to service business logic 64, which may indicate whether the recipient is internal or external (arrow response).

In the case of a communication either to or from a user who previously registered to use rich content delivery system 8, further processing may be possible that may, for example, take user preferences into account.

A request may be sent to presence unit 26 for information related to the sender and/or recipient(s) (arrow request-sender/recipient) as appropriate. Presence unit 26 may further send a request to data access layer 62 for the required information and may further ensure a secured session (arrow request-fetch). Data layer 62 may send the response to presence unit 26 (arrow response), which may forward it to service business logic 64 (2^{nd} arrow response). The path may continue from “B” at either “B1” or B2”.

Path 3, starting at “B1” (from “B”), may be taken by a communication being sent to an external system. The response may be sent back to control unit 60 (arrow response-external). It may be sent to content transcoder 70 of content handler 52 (arrow request-transcode). The results of transcoding may be sent back to control unit 60 (arrow response). It may be routed via operator services interface 28 or external systems interface 29 (arrow outgoing) to operator services 30 or external systems 31 (2^{nd} arrow outgoing) and on to a client device 20 (arrow deliver).

Path 4, starting at “B2” (from “B”) may be taken by a communication being sent to an internal client. The response may be sent back to control unit 60 (arrow response-internal). It may be sent to content transcoder 70 of content handler 52 (arrow request-transcode). The results of transcoding may be sent back to control unit 60 (arrow response). It may be routed via internal client interface 22 (arrow outgoing) and on to a client device 20 (arrow deliver).

Reference is now made to FIG. 6B, which is a flow chart diagram of a rich content delivery method, in accordance with an embodiment of the present invention. An internal communication may be received by the internal client interface (step 100). Alternatively, an external communication may be received by either the operator services interface or the external systems interface (step 102). In either case, the communication may be sent to an initial information extraction unit, which may extract information which may be necessary to begin processing and may perform a first check of the communication (step 104). The extracted information may include, for example, communication type, service requested, and recipient. The initial check may include, for example, whether the communication looks complete and correct.

The initial processing may generate various information requests, which may be routed by the rich content unit to the proper modules (step 106). The service logic may be determined (step 112). This may include details, for example, of the service and proper delivery for the service. The presence information may be determined (step 120). This may include information, for example, regarding the availability of the recipient(s), the device(s) they may be logged onto, and the capabilities of the devices.

Envelope information may be extracted and transcoded as necessary (step 125). For example, addressing information may be transcoded to comply with the receiving protocol. The various contents of the communication may them be transcoded (step 130), for example, to conform to device capabilities or optimal delivery.

A check may be made as to whether the outgoing communication(s) will be delivered internally or externally (step 135). It is noted that communications may be sent to more than one recipient at a time and that some may be internal recipients and some external. Internal communications may be sent to the internal interface unit (step 140) and may be sent to the internal client device(s) (step 142). External communications may be sent to any of the external interface units (step 150) and may be sent to the external client device(s) (step 152).

The present invention may allow optimized delivery. The presence, policy, and transcoding systems, may allow for the best delivery according to various criteria, including: quality, time, user preferences, and operator configuration requirements.

Quality of delivery may be ensured by the use of presence unit 26 in conjunction with other components of rich content unit 24 which may determine the various device capabilities of the recipient, the static configurations of the devices and buddies, rule-units (such as service business logic 64 and policy 50), and dynamic capabilities exchange. This combination of elements may allow rich content delivery system 8 to determine the current available set of attributes of a recipient user. Hence, delivery may be as instant as allowed by the limitations of the devices. Furthermore, the use of transcoding and protocol bridges may ensure that the information in the communication may be converted to the best possible format for the recipient given the device currently in use.

Timely delivery may be ensured even on a complex multimedia communication such as an animated slide presentation. For example, if the recipient is in his car with a PDA, instead of waiting for him to reach the office, the present invention may use the transcoders to “reduce” slightly the quality of the communication (e.g. smaller screen size, no animations etc.) to comply with the limitations of the PDA but allow immediate delivery. Later when the recipient arrives in the office he may view the full computer version, although, during his trip, he may immediately request more slides, fix some missing parts, and reply to the sender with comments.

The present invention may access network operator policies and preferences to optimize delivery, for example with regard to pricing and size. If a communication may be sent to multiple recipient at a cost of, for example, $1 and a single SMS communication costs $0.40; then when sending a communication to more than to 3 recipients it may be worthwhile to send a multiple recipient communication. However, but for 2 recipients the communication may be separated into 2 communications resulting in an $0.80 charge rather than $1. Waiting for specific hours (like after 21:00) to deliver non instant communications may result in a cheaper price. Accumulating some communications and sending them in a bunch may also save charges. A limit may be placed on size to preserve operator resources.

It should be noted that the above optimizations may demand contradictory solutions. In such a case, a rule-based system and configuration may allow the sender, recipients, and operator to tune their preferred optimizations rules.

Thus, it may be seen that the presence module and content modules may allow intelligent communication composition to meet various criteria (like quality, time, preferences, pricing, size etc.) according to sender/reciepients and operator policies.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A rich content instant delivery system comprising:
a rich content unit to send multi-media communications generally instantly;
a presence unit to communicate with said messaging unit; and
a network access layer to communicate with said rich content unit.

2. A rich content delivery system for wireless devices comprising:
a rich content unit to send multi-media communications to wireless devices; and
a presence unit to communicate with said rich content unit; and
a network access layer to communicate with said rich content unit.

3. A method for delivering a multi-media instant communication comprising:
initial processing of a multi-media instant communication;
routing of at least one information request generated by said initial processing;
determining service details of said communication;
discovering presence information;
extracting and transcoding envelope information of said communication;
transcoding content of said communication; and
sending a processed multi-media instant communication.
